(19) United States
(12) Patent Application Publication
(10) Pub. No.: US 2026/0336217 A1
(43) Pub. Date: Oct. 29, 2026

(54) ADDITIVE MANUFACTURING OF POROUS OBJECTS USING MIXING CHAMBER

(71) Applicant: International Business Machines Corporation, Armonk, NY (US)

(72) Inventors: Tushar AGRAWAL, West Fargo, ND (US); Jonathan COTTRELL, Canandaigua, NY (US); Sarbajit Kumar RAKSHIT, Kolkata (IN); Carolina GARCIA DELGADO, Zapopan (MX)

(21) Appl. No.: 19/188,427

(22) Filed: Apr. 24, 2025

(51) Int. Cl. B29C 64/314; B29C 64/386; B33Y 40/10; B33Y 50/00

(52) U.S. Cl. CPC B29C 64/314; B29C 64/386; B33Y 40/10; B33Y 50/00

(57) ABSTRACT

In some implementations, a device may receive an indication of one or more additive manufacturing object geometric parameters and one or more additive manufacturing object porousness parameters. The device may transmit, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material. The device may transmit one or more commands to construct an additive manufacturing object using the porous material.

### BACKGROUND

This disclosure relates to additive manufacturing, and more specifically, to additive manufacturing of porous objects using a mixing chamber.

### SUMMARY

Some aspects described herein relate to a computer-implemented method. The computer-implemented method may include receiving, by a device, an indication of one or more additive manufacturing object geometric parameters and one or more additive manufacturing object porousness parameters. The computer-implemented method may include transmitting, by the device, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material. The computer-implemented method may include transmitting, by the device, one or more commands to construct an additive manufacturing object using the porous material.

Some aspects described herein relate to a computer system. The computer system may include a processor set, one or more computer-readable storage media, and program instructions stored on the one or more computer-readable storage media to cause the processor set to perform operations. The operations may include receiving an indication of one or more additive manufacturing object geometric parameters and one or more additive manufacturing object porousness parameters. The operations may include transmitting, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material, where the one or more porosity control parameters are based on a detected porosity of the porous material. The operations may include transmitting one or more commands to construct an additive manufacturing object using the porous material.

Some aspects described herein relate to a computer program product. The computer program product may include one or more computer-readable storage media and program instructions stored on the one or more computer-readable storage media to perform operations. The operations may include receiving an indication of one or more additive manufacturing object geometric parameters and one or more additive manufacturing object porousness parameters. The operations may include generating, based on the one or more additive manufacturing object geometric parameters and the one or more additive manufacturing object porousness parameters, using an artificial intelligence model, one or more porosity control parameters that regulate an introduction of a gaseous material and an additive manufacturing material into a mixing chamber configured to produce a porous material using the gaseous material and the additive manufacturing material. The operations may include transmitting, based on the one or more additive manufacturing object geometric parameters and the one or more additive manufacturing object porousness parameters, one or more indications of the one or more porosity control parameters. The operations may include transmitting one or more commands to construct an additive manufacturing object using the porous material.

### BRIEF DESCRIPTION OF THE DRAWINGS

FIG. 1 is a diagram of an example computing environment for additive manufacturing of porous objects using a mixing chamber as described herein.

FIG. 2 is a diagram of an example associated with additive manufacturing of porous objects using a mixing chamber as described herein.

FIG. 3 is a diagram of example components of a device associated with additive manufacturing of porous objects using a mixing chamber.

FIG. 4 is a flowchart of an example process associated with additive manufacturing of porous objects using a mixing chamber.

### DETAILED DESCRIPTION

The following detailed description of example implementations refers to the accompanying drawings. The same reference numbers in different drawings may identify the same or similar elements.

Porous 3D-printed objects may include physical structures created using 3D printing technology that have deliberately incorporated voids (e.g., gaps, spaces, or the like) within the composition of the physical structures. These voids, formed during the 3D printing process, can serve a variety of purposes depending on the intended application. For example, porous 3D-printed objects may have lightweight structures that maintain structural integrity with reduced overall weight, and may have applications in weight-critical industries (e.g., aerospace, automotive, or the like). Additionally, or alternatively, porous 3D-printed objects may enhance heat dissipation in electronics and thermal management applications by increasing the surface area for air or coolant flow. Additionally, or alternatively, porous 3D-printed objects may be used for acoustic or vibration damping, such as by absorbing sound or dampening vibrations in architectural acoustics, automotive noise control, or other sound-related applications.

However, the porosity of a 3D-printed object is typically uniform. That is, a porous 3D-printed object typically has the same density of voids throughout the porous 3D-printed object. Uniform porosities can lead to issues with porous 3D-printed objects, such as structural failures (e.g., in cases where a portion of a porous 3D-printed object is too porous, and, thus, may not have sufficient structural integrity), insufficient heat dissipation (e.g., in cases where a portion of the porous 3D-printed object is too dense to allow for sufficient air or coolant flow), or insufficient acoustic or vibration damping (e.g., in cases where a portion of the porous 3D-printed object is too porous or too dense to provide sufficient sound absorption or vibration dampening), among other examples. As a result, a 3D printer may repeatedly 3D-print the same object, such as in cases where the object suffers damage due to structural failures, insufficient heat dissipation, or insufficient acoustic or vibration damping. Additionally, or alternatively, the 3D printer may execute intra- or post-printing operations that are designed to compensate for the uniform porosity, such as by adjusting infill density, layer thickness, or extrusion rates in different sections of the 3D-printed object. Repeatedly 3D-printing an object, and/or executing the intra- or post-printing operations, can consume excessive memory and processing resources of the 3D printer. Furthermore, the resulting objects may still be prone to premature structural failure, inadequate cooling, or insufficient acoustic or vibration damping due to the uniform porosity, which can lead to additional resource-intensive reprints or intra- or post-printing operations.

Some implementations described herein enable 3D-printing of an object with selective porosities in different portions of the object. In some examples, a mixing chamber may be integrated with a 3D printer. The mixing chamber may be configured to produce a porous 3D-printing material by mixing a gas (e.g., compressed air) with a 3D-printing material (e.g., molten filament). In some aspects, a computer may receive a 3D model of the object and an indication of one or more target porosities corresponding to one or more sections of the object. The computer may generate commands to adjust one or more 3D-printing parameters that control the porosity of the object based on the target porosities. For example, the parameters may control one or more variables of the mixing chambers, such as a flow rate of the gas and 3D-printing material into the mixing chamber, temperature, spin rate, pressure, or the like. The computer may transmit the commands to the mixing chamber, and the mixing chamber may prepare the porous material accordingly. In some examples, the mixing chamber may prepare a porous material of varying porosities throughout a 3D printing process. The 3D printer may produce the object, layer-by-layer, by extruding the porous material through a nozzle. The resulting 3D-printed object may include targeted porosities. For example, the 3D-printed object may include different levels of porousness (e.g., ranging from highly porous to highly dense) in different sections of the 3D-printed object. Thus, the 3D-printed object with selective porosities may have sections with improved structural integrity, heat dissipation, and/or acoustic or vibration damping. As a result, the 3D printer may execute fewer 3D prints of the same object, and/or fewer intra- or post-printing operations to compensate for a uniform porosity. Thus, the 3D printer may expend fewer memory or processing resources on such 3D prints and operations.

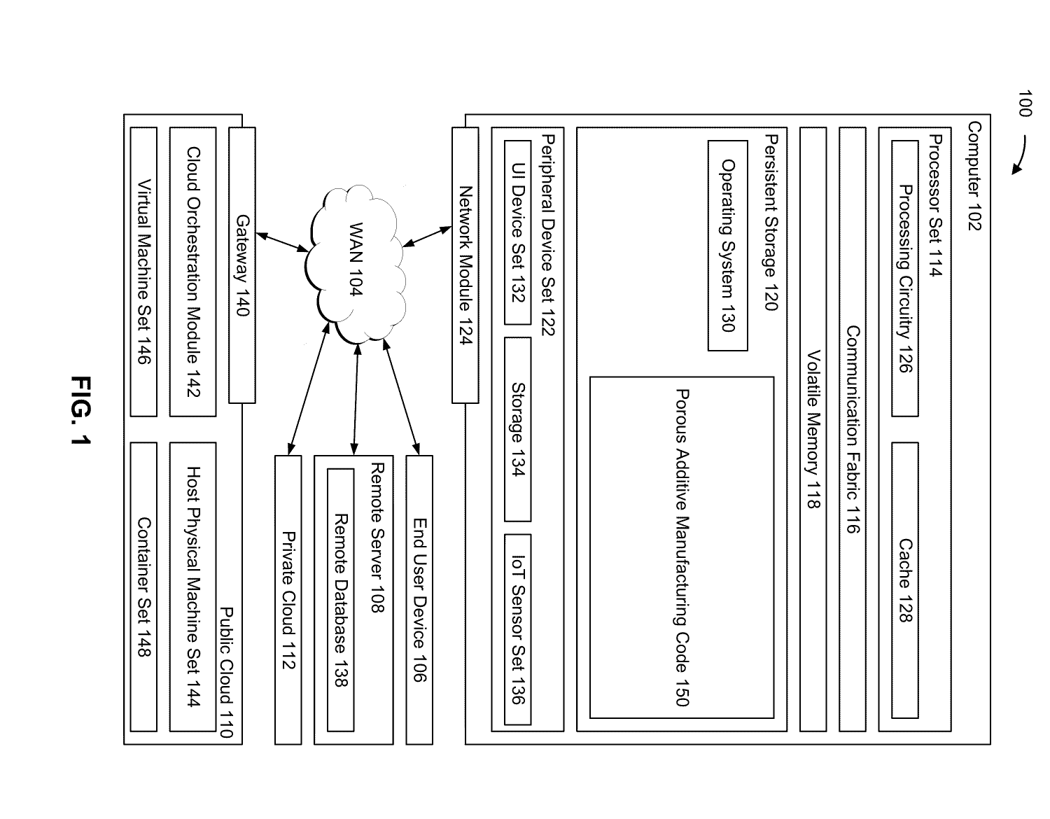

FIG. 1 is a diagram of an example computing environment 100 for additive manufacturing of porous objects using a mixing chamber as described herein.

The computing environment 100 contains an example of an environment for the execution of at least some of the computer code involved in performing the inventive methods, such as porous additive manufacturing code 150. In addition to the porous additive manufacturing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the porous additive manufacturing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in porous additive manufacturing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the porous additive manufacturing code 150 typically includes at least some of the computer code involved in performing one or more operations described herein. The operations may include, for example, receiving an indication of one or more additive manufacturing object geometric parameters and one or more additive manufacturing object porousness parameters; transmitting, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material; and transmitting one or more commands to construct an additive manufacturing object using the porous material.

In some implementations, the operations may include receiving an indication of one or more additive manufacturing object geometric parameters and one or more additive manufacturing object porousness parameters; transmitting, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material, wherein the one or more porosity control parameters are based on a detected porosity of the porous material; and transmitting one or more commands to construct an additive manufacturing object using the porous material.

In some implementations, the operations may include receiving an indication of one or more additive manufacturing object geometric parameters and one or more additive manufacturing object porousness parameters; generating, based on the one or more additive manufacturing object geometric parameters and the one or more additive manufacturing object porousness parameters, using an artificial intelligence model, one or more porosity control parameters that regulate an introduction of a gaseous material and an additive manufacturing material into a mixing chamber configured to produce a porous material using the gaseous material and the additive manufacturing material; transmitting, based on the one or more additive manufacturing object geometric parameters and the one or more additive manufacturing object porousness parameters, one or more indications of the one or more porosity control parameters; and transmitting one or more commands to construct an additive manufacturing object using the porous material.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

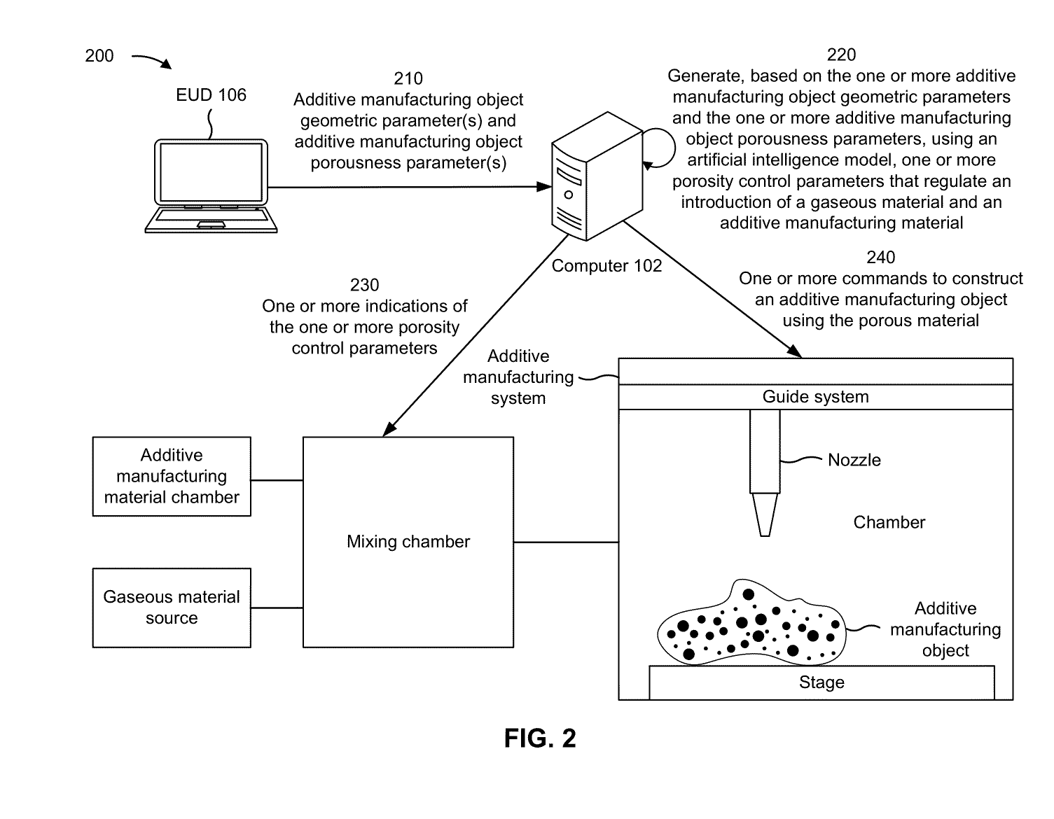

FIG. 2 is a diagram of an example 200 associated with additive manufacturing of porous objects using mixing chamber as described herein.

Example 200 shows the EUD 106, the computer 102, an additive manufacturing material chamber, a gaseous material source, a mixing chamber, and an additive manufacturing system. The additive manufacturing material chamber may be configured to store an additive manufacturing material, such as a filament (e.g., a 3D printing filament material). The gaseous material source may provide a gaseous material (e.g., compressed air, inert gas, or the like). For example, the gaseous material source may be a reliable air supply system, which may include a compressor and a pressure regulator, capable of providing a controlled and consistent flow of compressed air. The mixing chamber may be configured to produce a porous material using the gaseous material and the additive manufacturing material. For example, the mixing chamber may be configured to mix the gaseous material and the additive manufacturing material and thereby generate the porous material. The mixing chamber may be configured to handle high temperatures and pressures involved in additive manufacturing processes. In some examples, the mixing chamber may include an additive manufacturing material inlet that allows the additive manufacturing material to enter the mixing chamber and a gaseous material inlet that allows the gaseous material to enter the mixing chamber. For example, the mixing chamber may be configured to receive the filament via the additive manufacturing material inlet and melt the filament into molten filament, the gaseous material source may be configured to inject compressed air into the mixing chamber (e.g., on the molten filament) via the gaseous material inlet, and the mixing chamber may be configured to gradually, thoroughly, and consistently blend the air and molten filament (e.g., via rotation, agitation, or the like) to create one or more air bubbles inside the molten filament. In some examples, the inlets may have respective control valves that regulate a rate of entrance of the gaseous material and the additive manufacturing material.

In some examples, the additive manufacturing system (e.g., a 3D printer) may be configured to 3D print objects using one or more 3D printing techniques, such as additive manufacturing material extrusion. The objects that can be 3D printed by the additive manufacturing system are not limited to any particular type of object, and may include industrial components, consumer components, and/or other types of components. The additive manufacturing system may include a chamber and a stage within the chamber. The chamber may include an internal volume in which additive manufacturing of an object occurs. The stage may include a horizontal plane (e.g., a base plate, a chamber floor, or the like) that is configured to support and provide a surface on which an object is 3D printed. In some examples, a nozzle may be located within the chamber above the stage and coupled to a guide system that enables the nozzle to be moved and selectively positioned. The guide system may include a combination of belts, gears, motors, structures, and/or other components that enable the nozzle and to be moved according to a programmed path. In some examples, the guide system may include a gantry to which the nozzle is mounted. In some examples, the mixing chamber may be integrated into the additive manufacturing system. In some examples, the mixing chamber may be configured to provide the porous material to the additive manufacturing system (e.g., to the nozzle).

The computer 102 may be communicatively coupled to the additive manufacturing system and/or the mixing chamber. For example, the computer 102 may communicate with the additive manufacturing system and/or the mixing chamber over wired and/or wireless communication links using the communication fabric 116, the network module 124, or the like. The computer 102 may control various aspects of the operation of the additive manufacturing system, such as additive manufacturing of an object with a porous material, and/or the mixing chamber, such as preparation of the porous material. In some examples, the computer 102 may be a part of the additive manufacturing system and/or the mixing chamber, and may correspond to the control system of the additive manufacturing system and/or the mixing chamber (e.g., the computer 102 may be embedded in the form factor of the additive manufacturing system and/or the mixing chamber). In some examples, the computer 102 may be located remotely from the additive manufacturing system and/or the mixing chamber.

As shown by reference number 210, the EUD 106 may transmit, and the computer 102 may receive, an indication of one or more additive manufacturing object geometric parameters and one or more additive manufacturing object porousness parameters. The one or more additive manufacturing object geometric parameters may indicate physical attributes of an additive manufacturing object, such as a shape, a size, a structure, or the like. For example, the one or more additive manufacturing object geometric parameters may include one or more dimensions (e.g., length, width, or height), one or more shapes (e.g., circular, rectangular, triangular, or the like), one or more curvatures, one or more angles, or the like. In some examples, the computer 102 may receive an additive manufacturing object model that indicates the one or more additive manufacturing object geometric parameters. The one or more additive manufacturing object porousness parameters may indicate a target porousness (e.g., porosity specifications) of the additive manufacturing object. For example, the additive manufacturing object porousness parameters may include dimensions and location(s) of one or more volumes within a layer of the additive manufacturing object that is to include the porous material. Additionally, or alternatively, the additive manufacturing object porousness parameters may include a porosity (e.g., a density of voids) within the one or more volumes, and/or within a unit volume, of the layer. In example 200, the computer 102 receives the indication of the one or more additive manufacturing object geometric parameters and the one or more additive manufacturing object porousness parameters from the EUD 106; in other examples, the computer 102 may receive the additive manufacturing object geometric parameter(s) and additive manufacturing object porousness parameter(s) from a device or component that is different from the EUD 106, such as the remote server 108, the public cloud 110, the private cloud 112, the UI device set 132, or the like.

In some aspects, the computer 102 may receive an additive manufacturing object model of the additive manufacturing object and segment the additive manufacturing object model into one or more sections associated with respective porosities. For example, the computer 102 may analyze the additive manufacturing object model (e.g., which may indicate the one or more additive manufacturing object geometric parameters) and the one or more additive manufacturing object porousness parameters, and identify different target levels of porousness in different sections (e.g., spaces, segments, portions, layers, or the like) of the additive manufacturing object model. The computer 102 may segment the additive manufacturing object model into the sections having corresponding porosities. In some examples, the computer 102 may identify sections having porosities and calculate void space volume (e.g., air volume of a section), void density (e.g., air density of a section), or the like. The sections may have different sizes and dimensions, and/or the sections may have various concentrations within a unit volume of the additive manufacturing object model. Based on the porosities of the sections, the computer 102 may estimate a minimum volume of the additive manufacturing material and a minimum amount of the gaseous material that is to be used to produce the additive manufacturing object.

As shown by reference number 220, the computer 102 may generate one or more porosity control parameters based on the one or more additive manufacturing object geometric parameters and the one or more additive manufacturing object porousness parameters using an artificial intelligence (AI) model. For example, the AI model may be a machine learning (ML) model that uses deep learning techniques, such as neural networks, to control the mixing chamber. The computer 102 may provide, as input into the AI model, the one or more additive manufacturing object geometric parameters and the one or more additive manufacturing object porousness parameters. In some examples, the AI model may analyze the one or more additive manufacturing object geometric parameters and the one or more additive manufacturing object porousness parameters by performing complex pattern recognition. The computer 102 may receive, as output from the AI model, the one or more porosity control parameters. The one or more porosity control parameters may control a porosity of an additive manufacturing object. For example, the one or more porosity control parameters may regulate an introduction of the gaseous material and the additive manufacturing material into the mixing chamber. In some examples, one or more porosity control parameters may control the mixing of the additive manufacturing material and the gaseous material in the mixing chamber. For example, the one or more porosity control parameters may control one or more components of the mixing chamber, such as heating elements, fans, motors, or the like. For example, the AI model may use the one or more porosity control parameters to control the speed (e.g., a quantity of rotations per minute) and direction of the motor(s) of the mixing chamber. Additionally, or alternatively, the one or more porosity control parameters may control air pressure, temperature, and/or inlet or control valve settings to achieve or maintain target bubble characteristics. In some examples, the one or more porosity control parameters may maintain a target temperature, viscosity, and/or fluidity of the additive manufacturing material. If the computer 102 detects deviations from target specifications (e.g., target temperature, pressure, material flow, porosity, or the like), then the computer 102 and/or the AI model may perform real-time adjustments to reduce the deviations. In some examples, the AI model may be trained using historical additive manufacturing data, such as additive manufacturing material properties, temperatures, pressures, air-to-filament ratios, target porosity levels, or the like. For example, the historical additive manufacturing data may be obtained from successful additive manufacturing processes with various porosity levels and corresponding porosity control parameters (or data that can be controlled using the porosity control parameters). In some examples, the computer 102 and/or the AI model may generate the one or more porosity control parameters in real-time (e.g., during an additive manufacturing process). For example, the computer 102 may receive real-time data from sensors that monitor the mixing chamber for temperature, pressure, material flow, air-to-filament ratio, or the like. For example, the computer 102 and/or the AI model may fine-tune the air-to-filament ratio for different sections of the additive manufacturing object. Thus, the computer 102 and/or the AI model may continuously monitor the additive manufacturing process and dynamically adjust the one or more porosity control parameters to achieve a target porosity in the additive manufacturing object.

As shown by reference number 230, the computer 102 may transmit, and the mixing chamber may receive, one or more indications of the one or more porosity control parameters. For example, the mixing chamber may, based on the one or more porosity control parameters, adjust the control valve settings, which may impact the air-to-filament ratio and, thus, generation of air bubbles (e.g., the volume and/or size of the air bubbles). Additionally, or alternatively, the mixing chamber may, based on the one or more porosity control parameters, adjust the air pressure, temperature, or the like. Additionally, or alternatively, the mixing chamber may, based on the one or more porosity control parameters, adjust one or more components of the mixing chamber, such as heating elements, fans, or the like. Thus, the one or more indications of the one or more porosity control parameters may control how the mixing chamber mixes the gaseous material with the additive manufacturing material, and, thus, a porosity of the additive manufacturing object.

In some aspects, the one or more porosity control parameters may be based on a detected porosity of the porous material. For example, the computer 102 may receive real-time data from scanners (e.g., optical scanners, acoustic scanners, or the like) that monitor the additive manufacturing process (e.g., a porosity of the additive manufacturing object). If the computer 102 detects deviations from target porosity, then the computer 102 and/or the AI model may perform real-time adjustments to reduce the deviations. For example, the computer 102 and/or the AI model may transmit, and the mixing chamber may receive, the one or more porosity control parameters that prompt the mixing chamber to adjust the mixing of the gaseous material with the additive manufacturing material to achieve the target porosity of the porous material.

In some aspects, the one or more porosity control parameters may regulate a temperature of the additive manufacturing material. For example, the computer 102 may receive real-time data from one or more temperature sensors that monitor the temperature of the porous material. Additionally, or alternatively, the computer 102 may receive other real-time data (e.g., regarding a viscosity of the porous material, a porosity of the additive manufacturing object, or the like) that may impact, or be impacted by, temperature. If the computer 102 detects deviations from target specifications, then the computer 102 and/or the AI model may perform real-time adjustments to the temperature to reduce the deviations. For example, the computer 102 and/or the AI model may transmit, and the mixing chamber may receive, the one or more porosity control parameters that prompt the mixing chamber to adjust the temperature using one or more heating elements and/or fans. For example, the mixing chamber may have a temperature control system that maintain the additive manufacturing material in a molten state as the additive manufacturing material enters the mixing chamber. In some examples, regulating the temperature may also regulate the viscosity of porous material.

In some aspects, the one or more porosity control parameters may include one or more mixing control parameters associated with the mixing chamber. The one or more mixing control parameters may refer to variables that control how the gaseous material and additive manufacturing material are mixed together in the mixing chamber. For example, the mixing chamber may, based on the one or more porosity control parameters, adjust one or more components of the mixing chamber, such as motors. For example, the mixing chamber may, based on the one or more porosity control parameters, adjust the speed (e.g., a quantity of rotations per minute) and/or direction of the motor(s) of the mixing chamber. Thus, the one or more indications of the one or more porosity control parameters may control how the mixing chamber mixes the gaseous material with the additive manufacturing material, and, therefore, a porosity of the additive manufacturing object.

As shown by reference number 240, the computer 102 may transmit, and the mixing chamber may receive, one or more commands to construct the additive manufacturing object using the porous material. For example, the one or more commands may prompt the additive manufacturing system to move the nozzle and/or extrude the porous material from the nozzle (e.g., a 3D printing nozzle). For example, the mixing chamber may mix the porous material before the porous material exits (e.g., is applied through) the nozzle. This mixing may generate air bubbles within the porous material, resulting in a porous layer of the additive manufacturing object deposited from the nozzle. In some examples, before initiating the additive manufacturing process involving the construction of the additive manufacturing object, the mixing chamber may be calibrated or scanned by conducting tests with different materials and settings, making any adjustments to achieve the target porosity. For example, these tests may determine whether the mixing chamber is clean of potential contaminants.

In some aspects, the porous material may be associated with multiple porosities corresponding to respective sections of the additive manufacturing object. For example, the porous material may have different porosities that are used to construct the respective sections. For example, the one or more porosity control parameters may prompt the mixing chamber to dynamically adjust the porosity of the porous material, depending on the section that the additive manufacturing system is constructing. Thus, the additive manufacturing system may construct the additive manufacturing object with selective porousness (e.g., with various dimensions and concentrations of porosity) in different sections (e.g., layers).

In some aspects, the additive manufacturing object may include at least one solid section. The solid section may be a dense material without porosity (e.g. without air mixing). For example, the additive manufacturing system may construct the solid section using the additive manufacturing material (e.g., and not the gaseous material). For example, the additive manufacturing system may construct the solid section by extruding the additive manufacturing material from the nozzle while the control valve of the gaseous material inlet is closed. Additionally, or alternatively, the additive manufacturing system may construct the solid section by extruding the additive manufacturing material from the nozzle while the mixing chamber is bypassed. For example, the one or more porosity control parameters may prompt the mixing chamber to dynamically close the control valve of the gaseous material inlet, and/or prompt the mixing chamber to be bypassed. As a result, the additive manufacturing system may deposit the additive manufacturing material in a solid layer.

Transmitting the one or more indications of the one or more porosity control parameters that regulate the introduction of the gaseous material and the additive manufacturing material into the mixing chamber configured to produce the porous material using the gaseous material and the additive manufacturing material may help to improve a quality of porosity of the additive manufacturing object. For example, the additive manufacturing object may have sections with improved structural integrity, heat dissipation, and/or acoustic or vibration damping, among other examples. As a result, the additive manufacturing system may execute fewer additive manufacturing processes for identical additive manufacturing objects, and/or fewer additive manufacturing process operations to compensate for a uniform porosity of the additive manufacturing object. Thus, the additive manufacturing system may expend fewer memory or processing resources on such additive manufacturing processes and operations.

FIG. 2 is provided as an example. Other examples may differ from what is described with regard to FIG. 2.

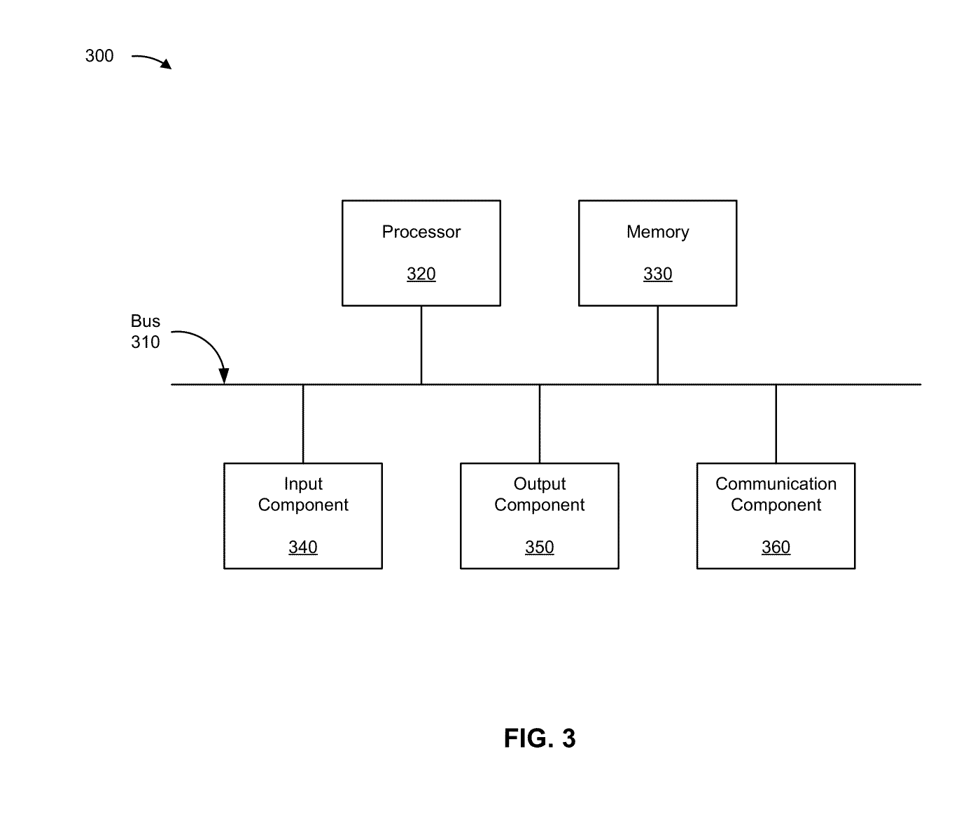

FIG. 3 is a diagram of example components of a device 300 associated with additive manufacturing of porous objects using a mixing chamber. The device 300 corresponds to one or more of the computer 102, EUD 106, the remote server 108, the public cloud 110, and/or the private cloud 112. In some implementations, the computer 102, EUD 106, the remote server 108, the public cloud 110, and/or the private cloud 112 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

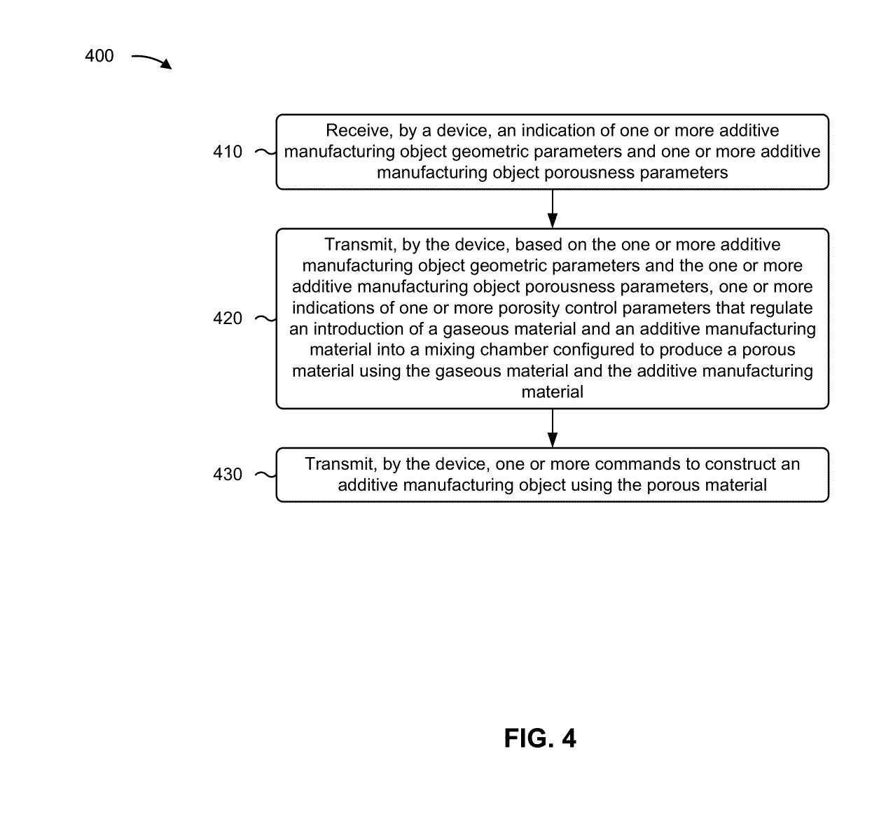

FIG. 4 is a flowchart of an example process 400 associated with additive manufacturing of porous objects using a mixing chamber. One or more process blocks of FIG. 4 are performed by a device (e.g., computer 102) and/or by another device or a group of devices separate from or including the device, such as a EUD (e.g., EUD 106), a remote server (e.g., remote server 108), a public cloud (e.g., public cloud 110) and/or a private cloud (e.g., private cloud 112). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving an indication of one or more additive manufacturing object geometric parameters and one or more additive manufacturing object porousness parameters (block 410). For example, the device may receive an indication of one or more additive manufacturing object geometric parameters and one or more additive manufacturing object porousness parameters, as described above.

As further shown in FIG. 4, process 400 includes transmitting, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material (block 420). For example, the device may transmit, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material, as described above.

As further shown in FIG. 4, process 400 includes transmitting one or more commands to construct an additive manufacturing object using the porous material (block 430). For example, the device may transmit one or more commands to construct an additive manufacturing object using the porous material, as described above.

Process 400 may include additional aspects, such as any single aspect or any combination of aspects described below and/or in connection with one or more other processes described elsewhere herein.

In a first aspect, process 400 includes generating, by the device, the one or more porosity control parameters using an artificial intelligence model.

In a second aspect, alone or in combination with the first aspect, the one or more porosity control parameters are based on a detected porosity of the porous material.

In a third aspect, alone or in combination with one or more of the first and second aspects, the porous material is associated with multiple porosities corresponding to respective sections of the additive manufacturing object.

In a fourth aspect, alone or in combination with one or more of the first through third aspects, the one or more porosity control parameters regulate a temperature of the additive manufacturing material.

In a fifth aspect, alone or in combination with one or more of the first through fourth aspects, the one or more porosity control parameters include one or more mixing control parameters associated with the mixing chamber.

In a sixth aspect, alone or in combination with one or more of the first through fifth aspects, the additive manufacturing object includes at least one solid section.

In a seventh aspect, alone or in combination with one or more of the first through sixth aspects, receiving the indication of the one or more additive manufacturing object geometric parameters and the one or more additive manufacturing object porousness parameters comprises receiving an additive manufacturing object model of the additive manufacturing object, and segmenting the additive manufacturing object model into one or more sections associated with respective porosities.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
receiving, by a device, an indication of one or more additive manufacturing object geometric parameters and one or more additive manufacturing object porousness parameters;
transmitting, by the device, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material; and
transmitting, by the device, one or more commands to construct an additive manufacturing object using the porous material.

2. The computer-implemented method of claim 1, further comprising:
generating, by the device, the one or more porosity control parameters using an artificial intelligence model.

3. The computer-implemented method of claim 1, wherein the one or more porosity control parameters are based on a detected porosity of the porous material.

4. The computer-implemented method of claim 1, wherein the porous material is associated with multiple porosities corresponding to respective sections of the additive manufacturing object.

5. The computer-implemented method of claim 1, wherein the one or more porosity control parameters regulate a temperature of the additive manufacturing material.

6. The computer-implemented method of claim 1, wherein the one or more porosity control parameters include one or more mixing control parameters associated with the mixing chamber.

7. The computer-implemented method of claim 1, wherein the additive manufacturing object includes at least one solid section.

8. The computer-implemented method of claim 1, wherein receiving the indication of the one or more additive manufacturing object geometric parameters and the one or more additive manufacturing object porousness parameters comprises:
receiving an additive manufacturing object model of the additive manufacturing object; and
segmenting the additive manufacturing object model into one or more sections associated with respective porosities.

9. A computer system comprising:
a processor set;
one or more computer-readable storage media; and
program instructions stored on the one or more computer-readable storage media to cause the processor set to perform operations comprising:
receiving an indication of one or more additive manufacturing object geometric parameters and one or more additive manufacturing object porousness parameters;
transmitting, based on the one or more additive manufacturing object geometric parameters and the one or more additive manufacturing object porousness parameters, one or more indications of one or more porosity control parameters that regulate an introduction of a gaseous material and an additive manufacturing material into a mixing chamber configured to produce a porous material using the gaseous material and the additive manufacturing material, wherein the one or more porosity control parameters are based on a detected porosity of the porous material; and
transmitting one or more commands to construct an additive manufacturing object using the porous material.

10. The computer system of claim 9, wherein the operations further comprise:
generating the one or more porosity control parameters using an artificial intelligence model.

11. The computer system of claim 9, wherein the porous material is associated with multiple porosities corresponding to respective sections of the additive manufacturing object.

12. The computer system of claim 9, wherein the one or more porosity control parameters regulate a temperature of the additive manufacturing material.

13. The computer system of claim 9, wherein the one or more porosity control parameters include one or more mixing control parameters associated with the mixing chamber.

14. The computer system of claim 9, wherein the additive manufacturing object includes at least one solid section.

15. A computer program product comprising:
one or more computer-readable storage media; and
program instructions stored on the one or more computer-readable storage media to perform operations comprising:
receiving an indication of one or more additive manufacturing object geometric parameters and one or more additive manufacturing object porousness parameters;
generating, based on the one or more additive manufacturing object geometric parameters and the one or more additive manufacturing object porousness parameters, using an artificial intelligence model, one or more porosity control parameters that regulate an introduction of a gaseous material and an additive manufacturing material into a mixing chamber configured to produce a porous material using the gaseous material and the additive manufacturing material;
transmitting one or more indications of the one or more porosity control parameters; and
transmitting one or more commands to construct an additive manufacturing object using the porous material.

16. The computer program product of claim 15, wherein the one or more porosity control parameters are based on a detected porosity of the porous material.

17. The computer program product of claim 15, wherein the porous material is associated with multiple porosities corresponding to respective sections of the additive manufacturing object.

18. The computer program product of claim 15, wherein the one or more porosity control parameters regulate a temperature of the additive manufacturing material.

19. The computer program product of claim 15, wherein the one or more porosity control parameters include one or more mixing control parameters associated with the mixing chamber.

20. The computer program product of claim 15, wherein the additive manufacturing object includes at least one solid section.
